(19) United States
(12) Patent Application Publication
(10) Pub. No.: US 2026/0163227 A1
(43) Pub. Date: Jun. 11, 2026

(54) ELECTRONIC DEVICE

(71) Applicant: PEGATRON CORPORATION, TAIPEI CITY (TW)

(72) Inventors: Chih-Wei Liao, Taipei City (TW); Hao-Hsiang Yang, Taipei City (TW); Chao-Hsu Wu, Taipei City (TW); Shih-Keng Huang, Taipei City (TW); Sheng-Chin Hsu, Taipei City (TW)

(73) Assignee: PEGATRON CORPORATION, TAIPEI CITY (TW)

(21) Appl. No.: 19/329,471

(22) Filed: Sep. 15, 2025

(30) Foreign Application Priority Data
Dec. 11, 2024 (TW) 113148268

(51) Int. Cl. H01Q 1/22; H01Q 1/48; H01Q 9/04

(52) U.S. Cl. CPC H01Q 1/2266; H01Q 1/48; H01Q 9/0407

(57) ABSTRACT

An electronic device includes an antenna module and a metal casing. The antenna module is disposed in the metal casing, is adapted to resonate at a frequency band, and includes an insulating base plate, two patch antennas, a grounding surface, and two grounding extension segments. The insulating base plate includes a first surface and a second surface opposite to each other. The patch antennas are disposed on the first surface, arranged side by side, and spaced apart along a first direction. Each patch antenna includes a central axis, a feeding end, and a center point. The feeding end is located on the central axis and deviates from the center point. A distance between the center points of the patch antennas is less than or equal to 0.5 times a wavelength of the frequency band. The grounding extension segments are connected to the grounding surface disposed on the second surface.

### CROSS-REFERENCE TO RELATED APPLICATION

This application claims the priority benefit of Taiwan application serial no. 113148268, filed on Dec. 11, 2024. The entirety of the above-mentioned patent application is hereby incorporated by reference herein and made a part of this specification.

### BACKGROUND

### Technical Field

The disclosure relates to an electronic device, and more particularly to an electronic device having an antenna with good positioning effect.

### Description of Related Art

When a conventional ultra-wideband positioning array antenna positions a positioning tag, signals measured by the positioning array antenna may overlap in phase, thereby causing angle misjudgment and affecting the positioning effect. Therefore, how to improve the positioning effect of the positioning array antenna is an issue driven to be explored in the art.

### SUMMARY

The disclosure provides an electronic device having an antenna with good positioning effect.

An electronic device of the disclosure includes an antenna module and a metal casing. The metal casing includes a side shell. The antenna module is disposed in the metal casing and is adapted to resonate at a frequency band. The antenna module includes an insulating base plate, two patch antennas, a grounding surface, and two grounding extension segments. The insulating base plate includes a first surface and a second surface opposite to each other. The two patch antennas are disposed on the first surface, and the two patch antennas are arranged side by side and spaced apart along a first direction. Each of the two patch antennas includes a central axis extending along a first direction, a feeding end, and a center point. The feeding end is located on the central axis and deviates from the center point. A distance between the center point of one of the two patch antennas and the center point of other one of the two patch antennas is less than or equal to 0.5 times a wavelength of the frequency band. The grounding surface is disposed on the second surface. The two grounding extension segments are connected to the grounding surface, and one of the two grounding extension segments extends to the side shell of the metal casing.

Based on the above, the antenna module of the electronic device of the disclosure can prevent phase overlap of measured signals, so as to facilitate a monotonous linear distribution of phases, which can prevent angle misjudgment, thereby having a good positioning effect.

### BRIEF DESCRIPTION OF THE DRAWINGS

FIG. 1 is a schematic view of an electronic device according to an embodiment of the disclosure.

FIG. 2 is a partially enlarged cross-sectional view of a region A of the electronic device of FIG. 1.

FIG. 3 is a top view of some components of an antenna module of FIG. 2.

FIG. 4 is a side view of the antenna module of FIG. 2 with a far-field plane wave incident thereon.

FIG. 5 is a top view of the far-field plane wave of FIG. 4 incident on one of multiple patch antennas.

FIG. 6 is a relationship diagram of angle Φ, angle θ, and phase difference of the electronic device 100 of FIG. 2.

### DESCRIPTION OF THE EMBODIMENTS

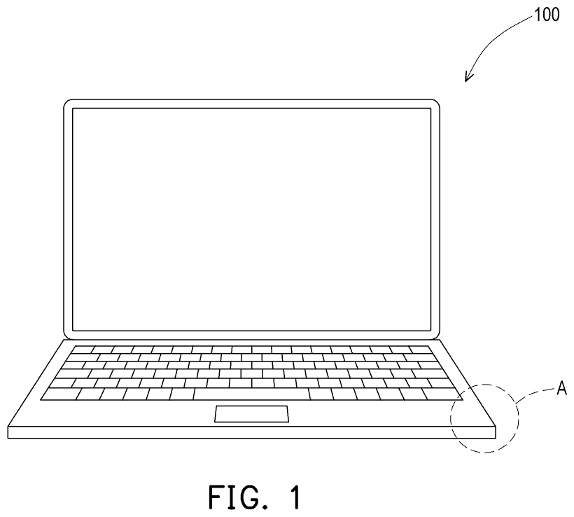

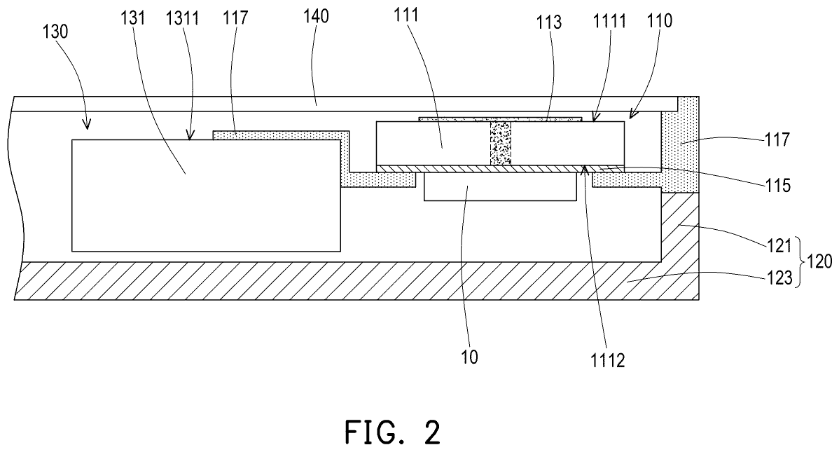

FIG. 1 is a schematic view of an electronic device according to an embodiment of the disclosure. FIG. 2 is a partially enlarged cross-sectional view of a region A of the electronic device of FIG. 1. Please refer to FIG. 1 and FIG. 2. An electronic device 100 of the embodiment is, for example, a notebook computer. The electronic device 100 includes an antenna module 110 and a metal casing 120. The antenna module 110 is disposed in the metal casing 120 (for example, a lower cover of the notebook computer) and is close to a side. The antenna module 110 of the embodiment is, for example, an ultra-wideband (UWB) phase difference of arrival (PDoA) positioning array antenna. In the embodiment, the antenna module 110 is disposed on a positioning anchor device, which belongs to two-dimensional plane scanning. When a user carrying a positioning tag device appears within a range of plus or minus 45 degrees in front of the electronic device 100, the electronic device 100 can accurately lock the user and unlock the screen without entering a password, and simultaneously execute a preset program software to improve the convenience of use. Alternatively, when the user is away from the electronic device 100, the electronic device 100 automatically turns off and locks the screen to prevent information leakage.

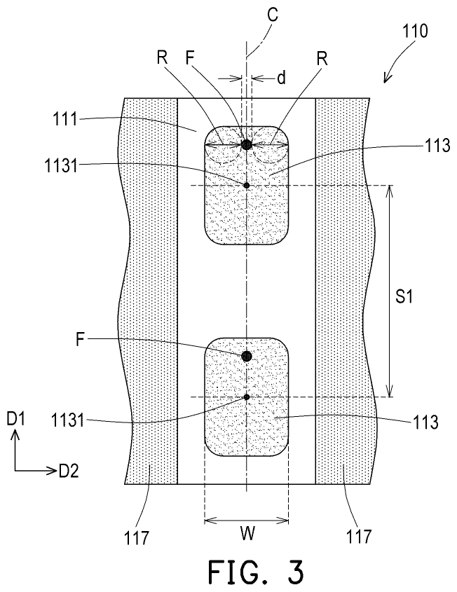

FIG. 3 is a top view of some components of the antenna module of FIG. 2. Please refer to FIG. 2 and FIG. 3. The antenna module 110 of the embodiment is adapted to resonate at a frequency band and includes an insulating base plate 111, two patch antennas 113, a grounding surface 115, and two grounding extension segments 117. The insulating base plate 111 includes a first surface 1111 and a second surface 1112 which are opposite to each other. The two patch antennas 113 are disposed on the first surface 1111. As shown in FIG. 3, the two patch antennas 113 are arranged side by side and spaced apart along a first direction D1. Each of the two patch antennas 113 includes a central axis C extending along the first direction D1, a feeding end F, and a center point 1131. The center point 1131 is located on the central axis C, and the feeding end F is located on the central axis C and deviates from the center point 1131. A distance S1 between the center point 1131 of one of the two patch antennas 113 and the center point 1131 of the other patch antenna 113 is less than or equal to 0.5 times the wavelength of the frequency band. The grounding surface 115 is disposed on the second surface 1112, and an ultra-wideband chip 10 is disposed on the grounding surface 115. The two grounding extension segments 117 are connected to the grounding surface 115. The metal casing 120 includes a side shell 121, and one of the two grounding extension segments 117 extends to the side shell 121.

A positioning manner of the antenna module 110 is described in detail below.

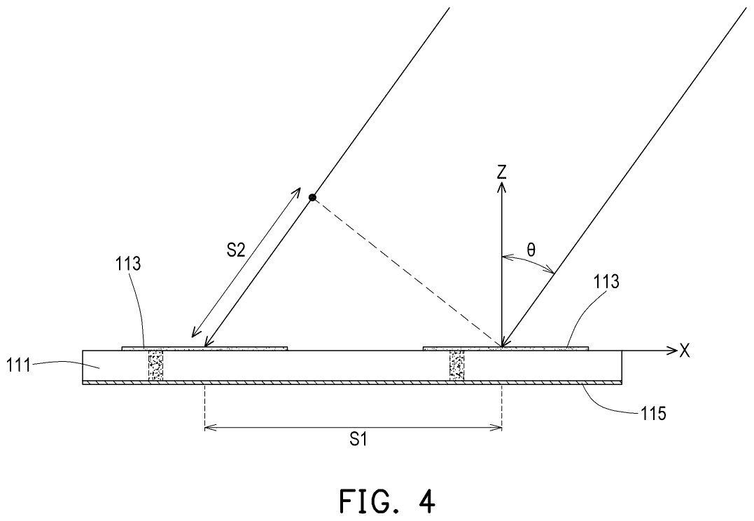

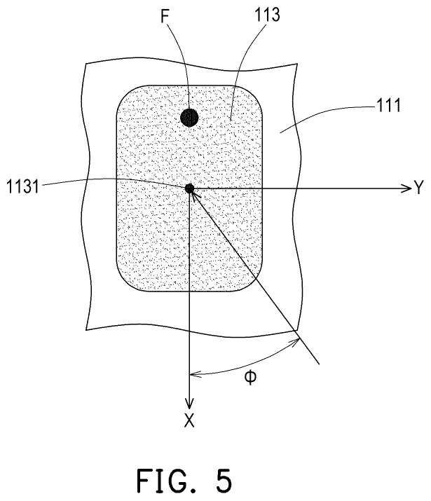

FIG. 4 is a side view of the antenna module of FIG. 2 with a far-field plane wave incident thereon. FIG. 5 is a top view of the far-field plane wave of FIG. 4 incident on one of the patch antennas. Please refer to FIG. 4 and FIG. 5. When the far-field plane wave is incident on the antenna module 110, the incident wave has an angle Φ with the axial direction X as shown in FIG. 5, and the incident wave has an angle θ with the axial direction Z as shown in FIG. 4. For example, when the incident wave is parallel to the axial direction Z, the angle θ is 0 degrees. When the incident wave is parallel to the axial direction X, the angle Φ is 0 degrees and the angle θ is 90 degrees. In the embodiment, the first direction D1 as shown in FIG. 3 is parallel to the axial direction X, and a second direction D2 as shown in FIG. 3 is parallel to an axial direction Y, but not limited thereto.

The phase difference of the far-field plane wave reaching the two patch antennas 113 of the antenna module 110 is a distance S2 as shown in FIG. 4, and the angle θ and the angle Φ of the far-field plane wave incident may be calculated to position the direction of the signal. In addition, the antenna module 110 may also calculate the distance between the electronic device 100 and the user according to the propagation time of the round-trip signal.

It is worth mentioning that the electronic device 100 of the embodiment can prevent phase overlap of the signals measured by the antenna module 110 by configuring the distance S1 between the two center points 1131 of the two patch antennas 113 to be less than or equal to 0.5 times the wavelength of the frequency band, so as to facilitate a monotonous linear distribution of the phases, which can prevent angle misjudgment, thereby having a good positioning effect.

In the embodiment, the angle range that the antenna module 110 may detect is that the angle Φ is between plus or minus 45 degrees and the angle θ is between plus or minus 60 degrees, so that the field of view (FOV) is as high as 90 degrees, which may support signal phase difference of arrival positioning and ranging applications to support human presence detection (HPD). However, the angle range that the antenna module 110 may detect is not limited to the above.

In the embodiment, the frequency band resonated by the antenna module 110 is between 7737 MHz and 8237 MHz, and is applicable to the frequency band of the ultra-wideband channel 9 (with the center frequency of 8 GHz) in the United States, Europe, Japan, South Korea, and China. In addition, the distance S1 between the two center points 1131 of the two patch antennas 113 is 16.9 mm (that is, 0.45 times the wavelength), but the disclosure does not limit the distance S1 between the two center points 1131. In other embodiments, the distance S1 between the two center points 1131 may also be any distance less than or equal to 18.75 mm (that is, 0.5 times the wavelength).

In the embodiment, the patch antenna 113 is, for example, a single-band antenna and has a direct probe feeding structure by a through hole. In addition, in the embodiment, the overall size of the insulating base plate 111, the two patch antennas 113, and the grounding surface 115 of the antenna module 110 is, for example, 28.9×10×1.6 mm, but not limited thereto.

In order for the two patch antennas 113 to achieve substantially consistent amplitude and phase, in the embodiment, a coplanar waveguide (CPW) transmission line (not shown) with an impedance of 50 ohms is disposed on the second surface 1112 of the insulating base plate 111, and two identical corresponding feeding ends F are used. One end of the coplanar waveguide transmission line is electrically connected to the feeding end F, and the other end is electrically connected to the ultra-wideband chip 10, and a phase compensation adjustment is performed on the length according to the phase difference value of the received signals to achieve phase calibration.

Please refer to FIG. 3. Each of the two patch antennas 113 of the embodiment is a rectangle with four arced corners, so as to provide a current path having an effective peripheral length corresponding to a local extension at a chamfered corner. Accordingly, without adding tuning matching circuit elements, the arced corners of the two patch antennas 113 can improve the impedance matching bandwidth.

In the embodiment, as shown in FIG. 3, the diameter of the circle formed by the arc of each of the four arced corners is a length R, the width of the feeding end F is a length d, and a length W of the patch antenna 113 along the second direction D2 is 2R+d. In the embodiment, the second direction D2 is perpendicular to the first direction D1. In addition, the value of 2R+d is, for example, 6 mm. However, the relationship between the length W and the length R and the length d of the patch antenna 113 is not limited thereto.

Please refer to FIG. 2 and FIG. 3. The two grounding extension segments 117 of the antenna module 110 extend from the grounding surface 115 toward opposite directions to outside the grounding surface 115 as shown in FIG. 2. The grounding extension segment 117 is, for example, a laser direct structuring (LDS) totem, but not limited thereto. The configuration of the grounding extension segment 117 in the electronic device 100 is described in detail below.

Please refer to FIG. 2. The electronic device 100 of the embodiment further includes an electronic assembly 130 (for example, a speaker box). The metal casing 120 further includes a bottom shell 123. The metal casing 120 is disposed below a non-metal member 140 (for example, a notebook computer keyboard). The electronic assembly 130 is disposed in the metal casing 120, and the antenna module 110 is located between the side shell 121 and the electronic assembly 130. As mentioned above, one of the two grounding extension segments 117 extends to the side shell 121 and extends along the side shell 121 toward a direction away from the bottom shell 123. The other one of the two grounding extension segments 117 extends to an upper surface 1311 of an insulating housing 131 of the electronic assembly 130.

In addition, the lengths of the two grounding extension segments 117 (that is, the total lengths from the grounding surface 115 to the extension segment ends) are the same, and the two grounding extension segments 117 are symmetrically disposed on two sides of the grounding surface 115. The length of each of the two grounding extension segments 117 is greater than or equal to 0.5 times the wavelength of the frequency band, and the extension length and area in the orthogonal direction to the patch antenna 113 may be flexibly adjusted according to the phase difference distribution in space.

It is worth mentioning that the electronic device 100 of the embodiment forms a continuous grounding surface by the two grounding extension segments 117 to form a phase difference positioning array antenna design structure with an electrically balanced grounding surface, thereby effectively reducing or eliminating phase overlap at higher frequencies, so that the angle Φ has a wider coverage range. Furthermore, the grounding extension segment 117 on the right side as shown in FIG. 2 extends to the metal casing 120, so that the antenna module 110 may be grounded to the metal casing 120, such that the response effect of the antenna module 110 is concentrated, and the grounding extension segment 117 on the left side as shown in FIG. 2 extends to the insulating housing 131 of the electronic assembly 130, and the length is symmetrical to the grounding extension segment 117 on the right side to prevent generation of phase ripples, so as to prevent unconcentrated response effect, thereby preventing the failure of the positioning effect and implementing a more linearly dependent signal phase difference of arrival performance. Accordingly, the electronic device 100 of the embodiment can still provide a good positioning effect in the case where the bandwidth reaches 500 MHz and the detection angle range reaches 90 degrees.

In the embodiment, the material of the grounding extension segment 117 is, for example, conductive foam, aluminum foil, or copper foil, but not limited thereto. In addition, in the embodiment, the length of each of the two grounding extension segments 117 is, for example, greater than or equal to 18.75 mm. In addition, in the embodiment, the material of the non-metal member 140 may be, for example, plastic, carbon fiber, leather, ceramic, or glass, but may also be other low microwave loss materials, which is not limited in the disclosure.

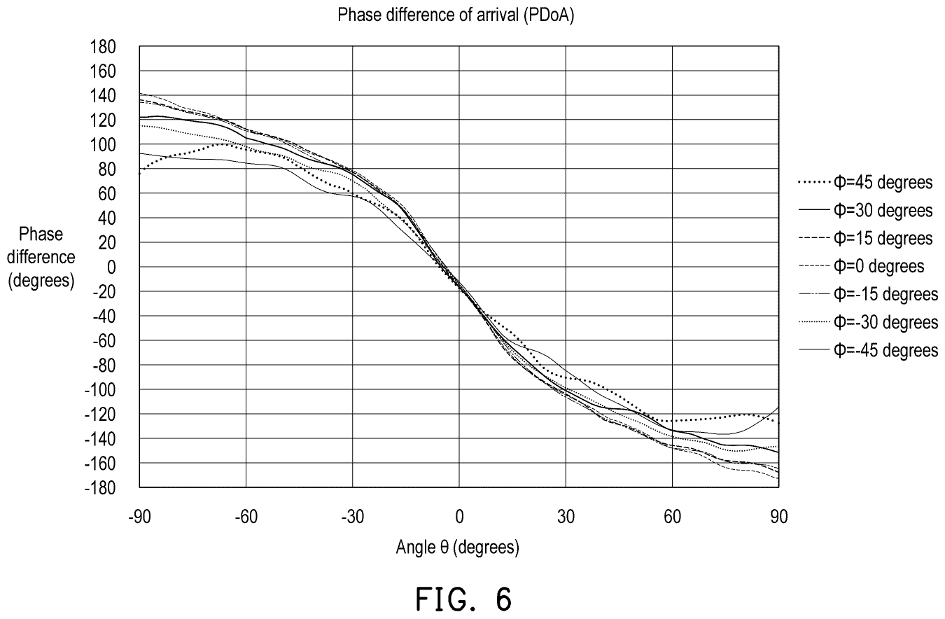

FIG. 6 is a relationship diagram of the angle Φ, the angle θ, and the phase difference of the electronic device 100 of FIG. 2. Please refer to FIG. 6. When the angle Φ of the signal is between plus or minus 45 degrees and the angle θ is between plus or minus 60 degrees, the phase difference of the signals detected by the antenna module 110 of the electronic device 100 of the embodiment has a smaller vibration amplitude and has a good positioning effect. In addition, the voltage standing wave ratio (VSWR) of each patch antenna 113 of the antenna module 110 of the embodiment is less than 3.5, the isolation is greater than 20 dB, and the antenna efficiency is greater than −3 dB, so that the antenna module 110 has a good performance. Furthermore, the enlarged balanced grounding surface (that is, the two grounding extension segments 117) has the benefit of improving the antenna front to back ratio (that is, suppressing side lobes and back lobes), increasing the energy of the antenna radiation pattern to the upper hemisphere to aim at the user from the front or the side.

In summary, the antenna module of the electronic device of the disclosure includes the two patch antennas arranged side by side and spaced apart. The feeding end of each patch antenna deviates from the center point, and the distance between the two center points of the two patch antennas is less than or equal to 0.5 times the wavelength of the frequency band. Accordingly, the antenna module of the electronic device of the disclosure can prevent phase overlap of the measured signals, so as to facilitate the monotonous linear distribution of the phases, which can prevent angle misjudgment, thereby having a good positioning effect. In addition, the antenna module of the disclosure further includes the two grounding extension segments. One of the two grounding extension segments is grounded to the metal casing and the other one is symmetrically disposed in length, which can prevent phase ripples and can further reduce phase overlap at high frequencies, so as to ensure the positioning effect of the antenna module.

What is claimed is:

1. An electronic device, comprising:
a metal casing, comprising a side shell; and
an antenna module, disposed in the metal casing and adapted to resonate at a frequency band, the antenna module comprising:
an insulating base plate, comprising a first surface and a second surface opposite to each other;
two patch antennas, disposed on the first surface, wherein the two patch antennas are arranged side by side and spaced apart along a first direction, each of the two patch antennas comprises a central axis extending along the first direction, a feeding end, and a center point, the feeding end is located on the central axis and deviates from the center point, and a distance between the center point of one of the two patch antennas and the center point of another one of the two patch antennas is less than or equal to 0.5 times a wavelength of the frequency band;
a grounding surface, disposed on the second surface; and
two grounding extension segments, connected to the grounding surface, wherein one of the two grounding extension segments extends to the side shell of the metal casing.

2. The electronic device according to claim 1, wherein each of the two patch antennas is a rectangle with four arced corners.

3. The electronic device according to claim 2, wherein a diameter of a circle formed by an arc of each of the four arced corners is R, a width of the feeding end is d, a length of the patch antenna along a second direction is 2R+d, and the second direction is perpendicular to the first direction.

4. The electronic device according to claim 1, wherein the two grounding extension segments extend from the grounding surface toward opposite directions to outside the grounding surface.

5. The electronic device according to claim 4, wherein lengths of the two grounding extension segments are the same, and the two grounding extension segments are symmetrically disposed on two sides of the grounding surface.

6. The electronic device according to claim 4, wherein a length of each of the two grounding extension segments is greater than or equal to 0.5 times the wavelength of the frequency band.

7. The electronic device according to claim 1, wherein the metal casing comprises a bottom shell, and the one of the two grounding extension segments extending to the side shell extends along the side shell toward a direction away from the bottom shell.

8. The electronic device according to claim 1, further comprising:
an electronic assembly, disposed in the metal casing, wherein the antenna module is located between the side shell and the electronic assembly, and another one of the two grounding extension segments extends to the electronic assembly.

9. The electronic device according to claim 8, wherein the electronic assembly has an insulating housing, and the another one of the two grounding extension segments extends to an upper surface of the insulating housing.

10. The electronic device according to claim 1, wherein the frequency band resonated by the antenna module is between 7737 MHz and 8237 MHz.
